(19) United States
(12) Patent Application Publication
(10) Pub. No.: US 2015/0326059 A1
(43) Pub. Date: Nov. 12, 2015

(54) SYSTEM AND METHOD FOR TRANSMITTING RF ENERGY

(71) Applicant: The Board of Trustees of The University of Alabama, Tuscaloosa, AL (US)

(72) Inventor: Jaber Abu Qahouq, Tuscaloosa, AL (US)

(21) Appl. No.: 14/705,034

(22) Filed: May 6, 2015

Related U.S. Application Data
(60) Provisional application No. 61/989,142, filed on May 6, 2014.

(51) Int. Cl. H02J 7/02; H02J 7/00

(52) U.S. Cl. CPC H02J 7/025; H02J 7/007

(57) ABSTRACT

Systems and methods for wirelessly harvesting power are disclosed. The method may include, for example, transmitting radio frequency waves to a receiver and receiving, using one or more antennas, the radio frequency waves. Further, the method may include extracting energy from the radio frequency waves. Transmitter and receiver RF circuitry may be provided to execute the disclosed methods.

### CROSS-REFERENCE TO RELATED APPLICATIONS

This application claims the benefit of U.S. Provisional Patent Application No. 61/989,142, filed on May 6, 2014, entitled “SYSTEM AND METHOD FOR TRANSMITTING RF ENERGY,” the disclosure of which is expressly incorporated herein by reference in its entirety.

### BACKGROUND

Portable consumer electronics are increasingly being used for additional tasks. For example, cell phones are being used for more complex tasks and often act as a replacement for a laptop computer. At the same time, there is increased demand for converting wired devices to wireless devices. For example, users may desire to have a wireless keyboard or wireless mouse to avoid the clutter of wires on a desk. The increased use of existing wireless devices, and the movement toward wireless devices, both require adequate battery life to avoid frustrating users.

A number of solutions have been proposed to increase battery life. For example, more efficient processors can be used that enter stand-by or reduced power modes when a cell phone is not being used. Toothbrushes, wireless mice, and other consumer electronics can also be placed on a dedicated charging station when not in use to have their batteries recharged with inductive power.

The solutions, however, can only partially address the problems associated with increased battery usage. Even as processors become more efficient, users want their devices to be available throughout an extended period of time. Further, a user may forget to place a device on a dedicated charging station. As a result, the batteries may be drained the next time a user attempts to use their device.

Accordingly, there is a need for systems and methods for wirelessly recharging electronic devices that do not require a dedicated charging station.

### SUMMARY

Systems and methods for wirelessly harvesting power are disclosed. The method can include, for example, transmitting radio frequency waves to a receiver and receiving, using one or more antennas, the radio frequency waves. Further, the method can include extracting energy from the radio frequency waves. Transmitter and receiver RF circuitry may be provided to execute the disclosed methods.

### BRIEF DESCRIPTION OF THE DRAWINGS

FIG. 1 illustrates a system for implementing an antenna and RF circuitry for wirelessly recharging batteries in a first exemplary embodiment.

FIG. 2 illustrates a system for implementing an antenna and RF circuitry for wirelessly recharging batteries in a second exemplary embodiment.

FIG. 3 illustrates a system for implementing an antenna and RF circuitry for wirelessly recharging batteries in a third exemplary embodiment.

FIG. 4 illustrates a system for implementing an antenna and RF circuitry for wirelessly recharging batteries in a fourth exemplary embodiment.

FIGS. 5A-C illustrate a system for implementing an antenna and RF circuitry for wirelessly recharging batteries in a fifth exemplary embodiment.

FIG. 6A illustrates a system for implementing an antenna and RF circuitry for wirelessly recharging batteries in a sixth exemplary embodiment.

FIG. 6B illustrates a system for implementing an antenna and RF circuitry for wirelessly recharging batteries in a seventh exemplary embodiment.

FIG. 7 illustrates a remote control for implementing an antenna and RF circuitry for wirelessly recharging batteries in the sixth and seventh embodiments.

FIG. 8 illustrates an exemplary system for implementing RF circuitry.

FIGS. 9A-9B illustrate exemplary environments for implementing wireless recharging of batteries. FIG. 9A illustrates a home environment. FIG. 9B illustrates an office environment.

### DESCRIPTION

The systems and methods described herein may use RF energy to provide power to a remote device wirelessly. Wireless devices, such as a toothbrush, mouse, keyboard, cell phone, or laptop may use RF circuitry that allows the device to be powered and recharge batteries. Moreover, wired devices, such as solar panels, may also harvest RF energy.

Devices that are currently wired may also be converted to wireless using the disclosed system. For example, lamps, set-top boxes, electric cars, and other electronic devices may use wireless energy harvesting to avoid the need for traditional cords connected to power outlets.

The RF circuitry may harvest power from ambient RF waves that exist from a variety of sources. Further, the RF circuitry may harvest power from RF waves that are transmitted from a dedicated RF power transmitter. For example, a computer that is connected to a power outlet may include a dedicated RF transmitter that transmits RF energy to a wireless display, keyboard, and mouse. This allows convenient recharging of wireless devices both during operation and when a device is not in use. Exemplary embodiments that use a dedicated RF transmitter for wireless energy harvesting are described in more detail below.

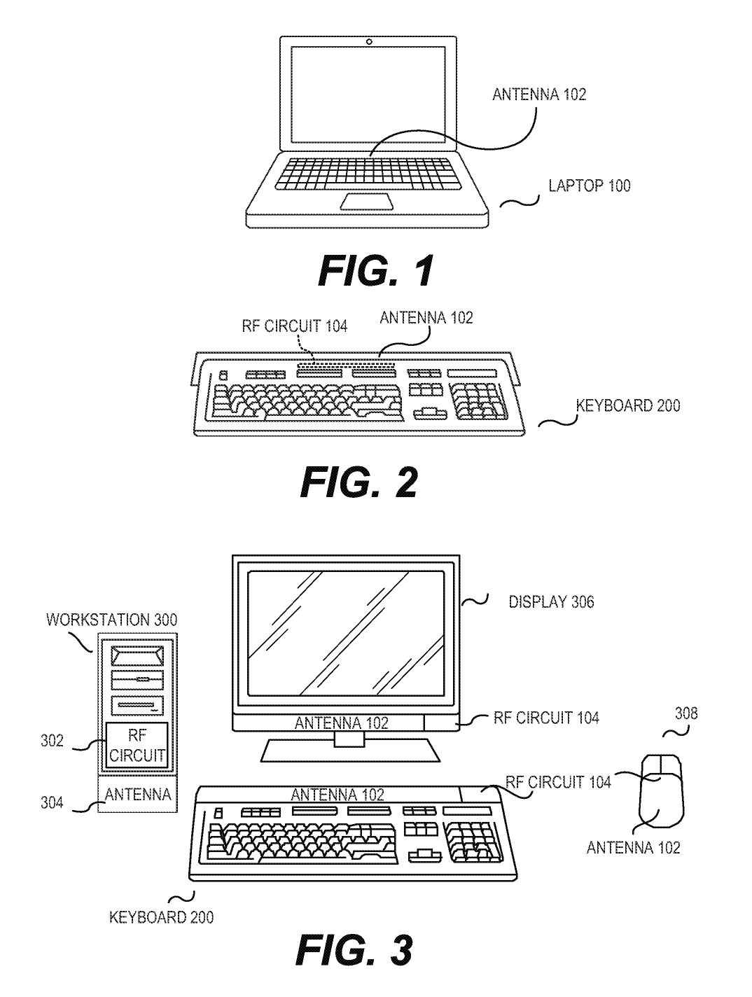

FIG. 1 illustrates a system for implementing an antenna and RF circuitry for wirelessly recharging batteries in a first exemplary embodiment. An antenna 102 may be incorporated into a laptop 100, such as in the area above a keyboard as illustrated. It may also be located on the side of laptop 100, around the display, or in a variety of other locations. The laptop 100 may use antenna 102 to transmit RF energy to wireless devices located nearby, such as a wireless mouse or cell phone. In FIG. 1, the laptop 100 transmits wireless energy to charge other devices (e.g., wireless keyboard, wireless mouse, cell phone) as opposed the laptop being charged by another device (i.e., receiving wireless energy transmitted by another device). Although one antenna 102 has been illustrated, a plurality of antennas may also be used. The antennas 102 may have different designs to provide different radio frequencies or other wireless energy forms, be aimed in the same or different directions, may have the same or different gain profiles, and may have the same or different radiation profiles. Similarly, laptop 100 may include receiving one or more antennas, which may vary in location, aim, gain profiles, and radiation profiles. The receiving antenna(s) may be used to receive wireless energy from another device, which can be used to charge the laptop 100.

FIG. 2 illustrates a system for implementing an antenna and RF circuitry for wirelessly recharging batteries in a second exemplary embodiment. The exemplary second embodiment includes a wireless keyboard 200. The wireless keyboard 200 may include an antenna 102 that receives RF waves and a RF circuit 104 that converts the RF waves into power for the keyboard and rechargeable batteries. As illustrated, RF circuit 104 may be located within the keyboard 200, and the antenna 102 in this exemplary embodiment may extend away from and along the keyboard 200.

FIG. 3 illustrates a system for implementing an antenna and RF circuitry for wirelessly recharging batteries in a third exemplary embodiment. In the third embodiment, a RF circuit 302 may be included in a PC workstation 300, and energy may be transmitted from antenna 304 to wireless devices located nearby. For example, a wireless display 306, keyboard 200, and mouse 308 may all include one or more antennas 102, located in a variety of different positions, and a RF circuit 104 for receiving the transmitted waves, converting the RF waves into energy, and powering the devices. Alternatively or additionally, display 306 can include the antenna 102 and RF circuit 104, which can be used to transmit energy to wireless devices located nearby.

RF circuit 302 may be built within workstation 300, and antenna 304 may be placed on the front and bottom area of workstation 300. On the display 306, antenna 102 may be provided along the bottom of a display, or surrounding the display, and RF circuit 104 may be within a base portion. In the example of a wireless keyboard 200 in FIG. 3, antenna 102 may extend along the top of the keyboard, with RF circuit 104 built within the keyboard 200. While these exemplary locations for RF circuits and antennas have been described, different or additional locations may also be selected to facilitate wireless RF energy harvesting.

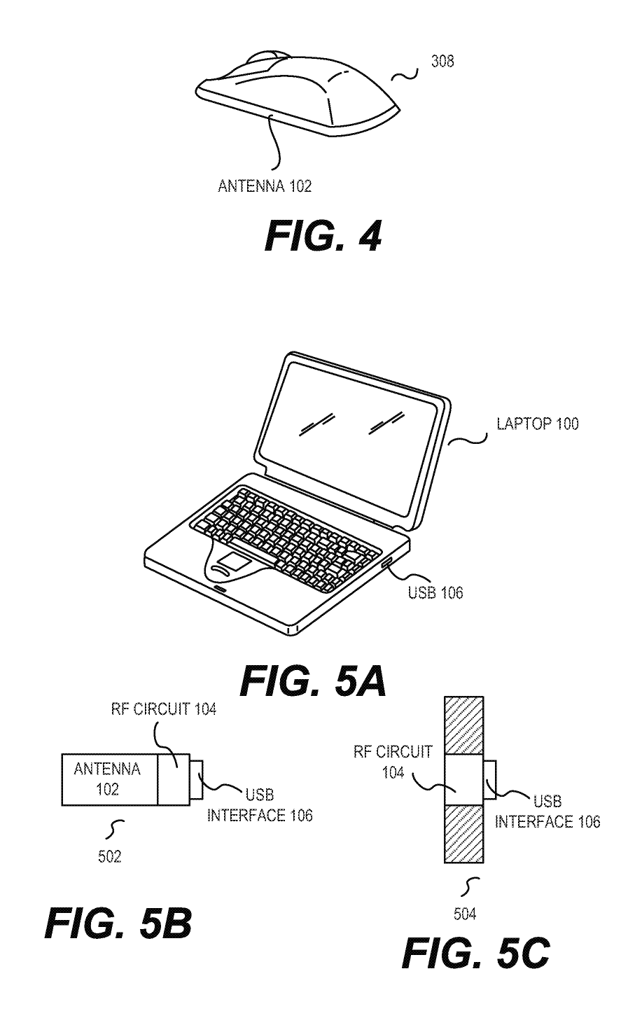

FIG. 4 illustrates a system for implementing an antenna and RF circuitry for wirelessly recharging batteries in a fourth exemplary embodiment. In this embodiment, a more detailed view of a wireless mouse 308 is illustrated. Antenna 102 may be provided around the base of mouse 308 on all sides, or on one, two, or three sides. Antenna 102 may receive transmitted RF waves and use the energy in the RF waves to power the wireless mouse 308. Although not illustrated, mouse 308 may also include RF circuitry for harvesting energy from the received RF waves.

The antenna 102 of the wireless mouse 308 may be integrated within the mouse casing. RF energy received by the antenna 102 may be transferred to an impedance matching network and a rectification stage. Output of the rectification stage may be regulated to a desired value and used to power the mouse components and circuits. The excess energy not used to power the mouse 308 may be stored in a battery and used later to supplement the received RF energy when the received RF energy is not sufficient to power mouse 308.

The source of RF energy can come from, for example, a computer 300, with an RF transmitting antenna 304 and an RF power circuit 302. The transmitting antenna 304 may be integrated in the casing of the computer 300 or monitor or it could be provided through a separate RF energy source. Moreover, as described below, the transmitting antenna may be integrated within a USB dongle which is plugged in the USB port of the computer 300. The USB port of the computer 300 may provide power transmitted using a RF signal to the mouse 308 or any other receiving device.

The wireless energy transmitters described herein such as the computer, monitor, USB dongle, and/or workstation can charge other devices such as medical devices such as a pacemaker device and/or a heart rate monitor, among others.

Further, the embodiments described herein, including the mouse embodiment, may use a triceiver with a three-mode antenna. Three-mode antennas may be used both to transmit and receive information while receiving RF energy at the mouse side or other consumer electronic device. The triceiver antenna may also transmit and receive information while transmitting RF energy at the computer or transmitter side.

FIGS. 5A-C illustrate a system for implementing an antenna and RF circuitry for wirelessly recharging batteries in a fifth exemplary embodiment. In this embodiment, a laptop 100 may include a USB port 106 as shown in FIG. 5A. A portable USB device with a USB interface 106, RF circuit 104, and antenna 102 may connect to the USB port. Two examples of USB devices are shown in FIG. 5B at 502 and in FIG. 5C at 504. In the exemplary USB interface shown at 502, the shape may take the form of a traditional USB storage device that is longer than it is narrow. In the example of 504, the USB device may have a shape that is wider than it is long. Of course, other shapes for USB devices may also be used. The USB devices connect to USB port 106 and allow power to be drawn from the laptop 100 and transmitted wirelessly using RF circuit 104 and antenna 102 to consumer electronics, such as a cell phone, wireless mouse, and wireless speakers.

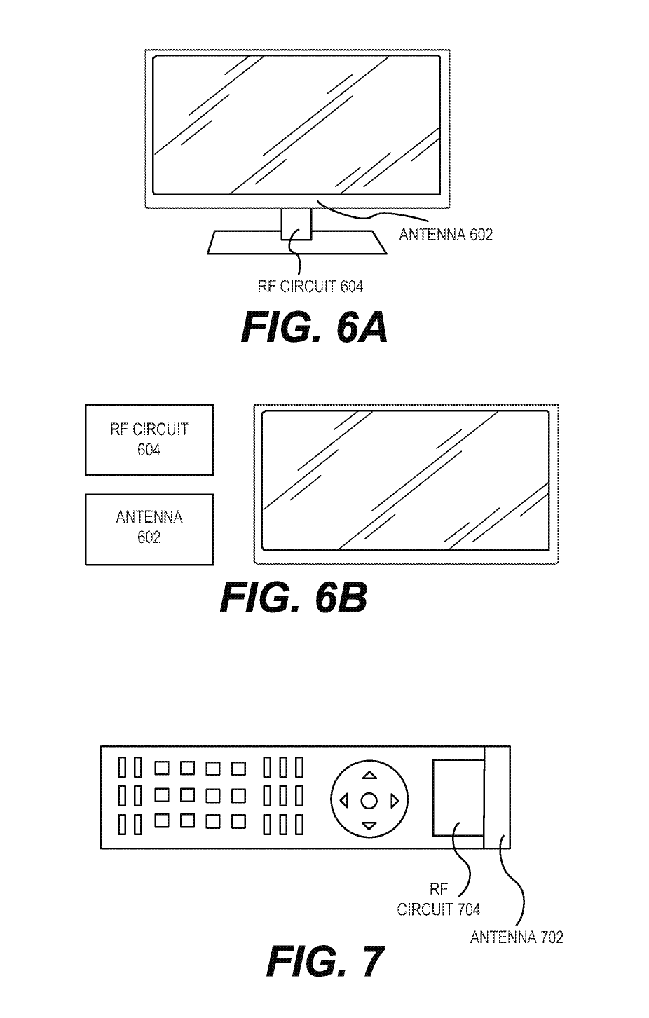

FIGS. 6A and 6B illustrate systems for implementing an antenna and RF circuitry for wirelessly recharging batteries in a sixth exemplary embodiment. In the embodiment of FIG. 6A, RF circuit 604 and antenna 602 may be integrated into a television. As shown in FIG. 6B, RF circuit 604 and antenna 602 may also be separate from the television and then connected to it to allow existing televisions to be retrofitted with the described RF transmitter technology.

RF circuit 104 within the television may provide a radio frequency wave to a remote control, shown in FIG. 7, which may include a receiver RF circuit 704 and antenna 702. Antenna 702 may receive the RF waves from antenna 602. RF circuit 704 may convert the

RF waves into power usable by the remote control for operation and for recharging batteries. As a result, the remote control may be constantly recharged to avoid the need to replace batteries. Although illustrated as being integrated into a television, the RF transmitter circuit could also be integrated into a gaming console, and the remote control may be used with the gaming console.

The receiving antenna may be integrated within the remote control casing to efficiently receive RF energy. The RF energy received by the antenna 702 may be transferred to an impedance matching network and a rectification stage. The output of the rectification stage may be regulated to a desired value and used to power the remote control components and circuits. Excess energy that is not used to power the remote control may be stored in one or more batteries, which can store RF energy when the remote control is not being used. Energy stored in the battery may be used later to supplement the received RF energy if the received energy is not sufficient to power the remote control.

The source of RF energy may come from the controlled device, for example, the TV, with an RF transmitting antenna 602 and an RF power circuit 604. The antenna on the transmitting device could be integrated in the casing of the TV or monitor or it could be provided through a separate RF energy source. The transmitting antenna 602 may be made with large surface area as large as the TV itself to allow the remote control to receive a higher amount of energy and at longer distance (in this/one embodiment/claim, the TV remote controller and other devices are wirelessly powered by wireless energy transmitted by the TV). The transmitting antenna 602 may also be integrated in the casing of a gaming console. Further, triceivers with a three-mode antenna may be used such that the same antenna transmits and receives information while receiving RF energy at the remote control side, and transmits and receives information while transmitting RF energy at the TV/game console or transmitter side.

While several exemplary embodiments for wireless RF charging have been explained, it will be appreciated that a variety of consumer electronics may receiver power through dedicated RF transmission circuitry, and also by capturing ambient RF waves for power. For example, a user may install a dedicated RF power transmitter within their house or vehicle that will provide power to any type of consumer electronics equipped with the RF antenna and receiver circuitry disclosed herein.

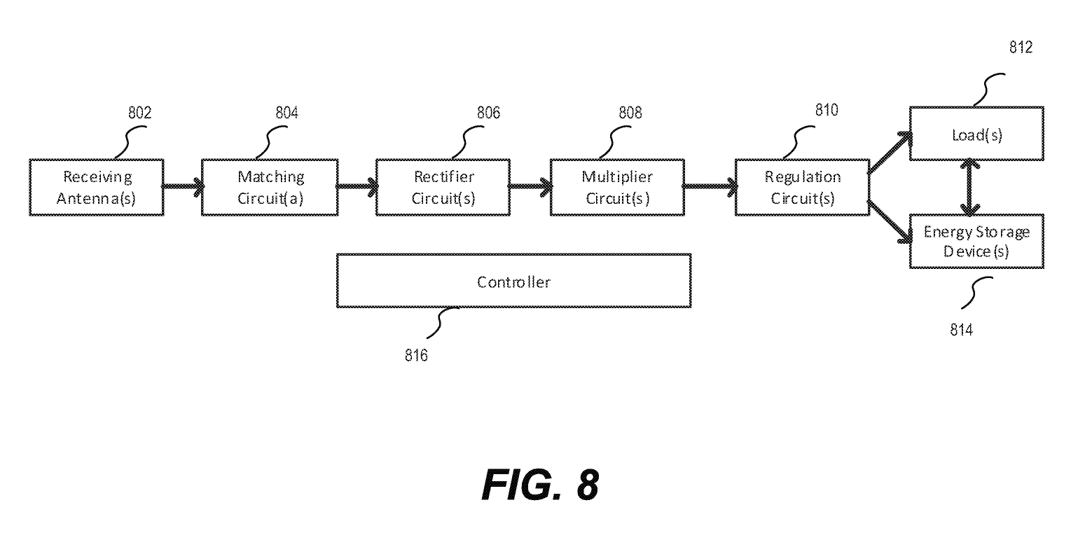

FIG. 8 illustrates an exemplary system for implementing RF circuitry within a receiver. Similar circuitry may be used within the transmitter. A device may be equipped with one or more receiving antennas 802. Matching circuits 804 may include one or more impedance matching circuits for receiving the RF waves. Rectifier circuits 806 may, for example, convert the received energy to DC energy or another form of AC energy. Multiplier circuits 808 may include one or more voltage or current multiplier stages which amplify (or attenuate) the level of the voltage or current of the RF received energy. One or more voltage, current, or power regulator circuits 810 may also regulate the voltage, current, or power to a desired value to power a load or more. The regulation circuits may provide power to one or more loads 812, such as the processor, display, and memory within a cell phone, and to energy storage devices 814, such as batteries within a cell phone.

Controller 816 may divide the amount of harvested energy into two or more parts. For example, a portion of the harvested energy may directly power load 812 and the other part may be directed to an energy storage device 814 like a battery.

If the RF available energy being received is more than is needed by the load being powered and/or larger than what can be stored in the device battery, the controller 816 may stop the process of receiving the RF energy and provide a signal (e.g., light) indicating that the battery has been fully charged. Controller 816 may also send a signal to the RF energy transmitter/source to enter a sleep mode and not transmit RF energy. The sleep mode may continue for a time interval, such as one minute, or may end when controller 816 indicates that RF transmission should resume in another command signal.

If the RF available energy being received is not sufficient to power the load, and the energy stored in the battery is not able to substitute for the shortage in the needed energy, controller 816 may turn the load off until there is enough energy stored in the battery from the received RF energy or until the RF energy is sufficient to power the load. The device may output a message to the user that power-down or a reduced power operation mode will occur. For example, a display message, vibration, sound, or light may be provided on a cell phone, or a light, sound, or vibration may be provided to a wireless device without a display. Controller 816 may also output a message to instruct the user to direct the device toward the RF energy source and or move closer to the RF energy source for efficient charging. The message could be viewed on the device itself or on another device such as the TV associated with the remote control, the computer associated with the mouse, the phone screen, or the game console associated with a game controller.

When a battery charge becomes low or when then amount of power that is needed to supply a load exceeds what can be obtained through RF energy charging, the device could be temporarily and automatically paused by the RF energy controller until sufficient energy is available. For example, a game or movie may be paused. The program may automatically resume once the controller determines that it can successfully power the load. Further, controller 816 and the controller in the RF energy transmitter may communicate information, such as the amount of available energy, distance of the connection, and an operation status (e.g. ON/OFF). The information can be viewed on a screen or indicated by color coded lights/LEDs.

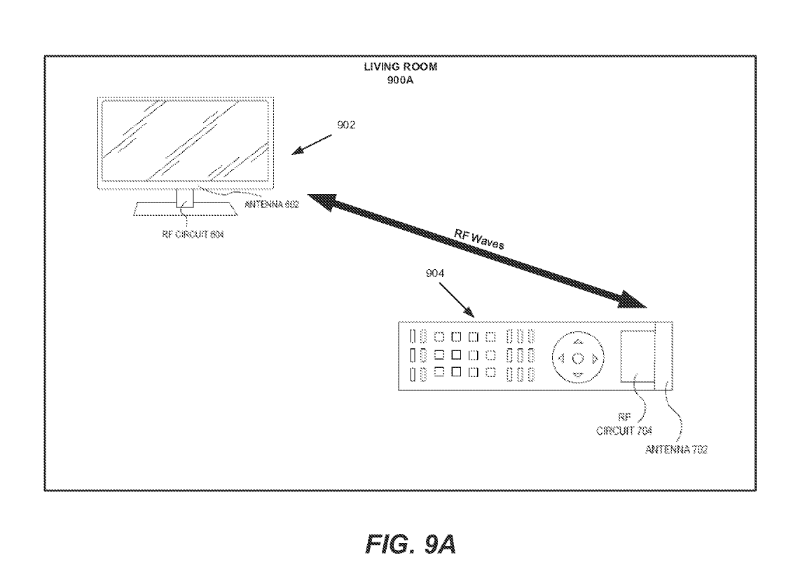

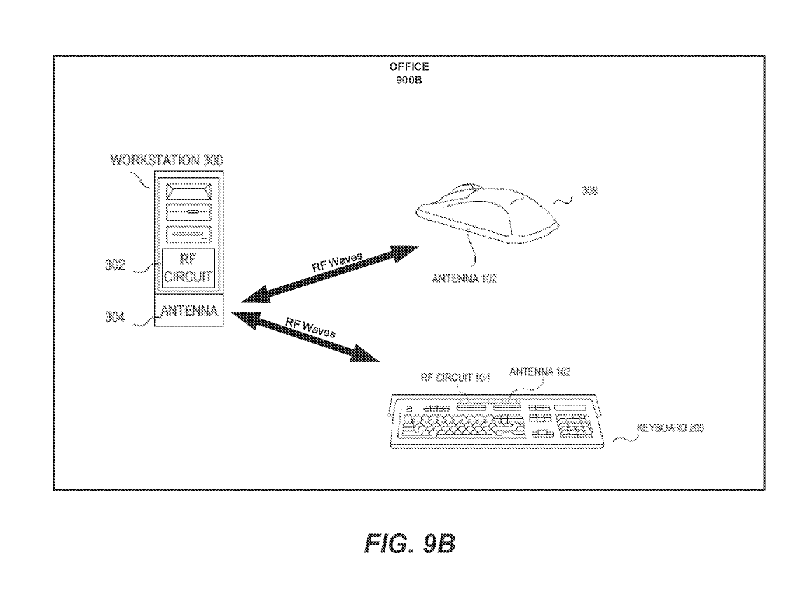

FIG. 9A illustrates a home environment such as a living room 900A, for example. The living room 900A can include a television 902 that is configured to transmit RF waves, which can be used to power and/or recharge a battery of another device. For example, as described above, RF circuit 604 and antenna 602 may be integrated into the television 902. It should be understood that devices other than the television 902 including, but not limited to, a gaming console, a computer workstation, a laptop, and/or a USB device may be situated in the living room 900A and may include the RF circuit and antenna for transmitting RF waves used to power and/or recharge a battery of another device. As shown in FIG. 9A, RF circuit 604 and antenna 602 within the television 902 may provide a radio frequency wave to a remote control 904, which may include a receiver RF circuit 704 and antenna 702. Antenna 702 may receive the RF waves from antenna 602 of the television 902. RF circuit 704 may convert the RF waves into power usable by the remote control 904 for operation and/or for recharging batteries. As a result, the remote control 904 may be constantly recharged to avoid the need to replace batteries. It should be understood that devices other than the remote control 904 including, but not limited to, a mouse, a keyboard, a monitor, a cell phone, a tablet computer, a laptop computer, a medical device (e.g., a pacemaker, a heart rate monitor, etc.), or other consumer electronic device may be situated in the living room 900A may include the RF circuit and antenna for receiving RF waves transmitted by the television 902.

FIG. 9B illustrates an office environment such as an office 900B. The office 900B can include a PC workstation 300 that is configured to transmit RF waves, which can be used to power and/or recharge a battery of another device. For example, as described above, RF circuit 302 and antenna 304 may be integrated into the PC workstation 300. It should be understood that devices other than the PC workstation 300 including, but not limited to, a gaming console, a television, a laptop, and/or a USB device may be situated in the office 900B and may include the RF circuit and antenna for transmitting RF waves used to power and/or recharge a battery of another device. As shown in FIG. 9B, RF circuit 302 and antenna 304 within the PC workstation 300 may provide a radio frequency wave to a wireless mouse 308 and/or a wireless keyboard 200, which may include a receiver RF circuit 104 (not shown in the wireless mouse 308) and antenna 102. Antenna 102 may receive the RF waves from antenna 304 of the PC workstation 300. RF circuit 104 may convert the RF waves into power usable by the wireless mouse 308 and/or the wireless keyboard 200 for operation and/or for recharging batteries. As a result, the wireless mouse 308 and/or the wireless keyboard 200 may be constantly recharged to avoid the need to replace batteries. It should be understood that devices other than the wireless mouse 308 and/or the wireless keyboard 200 including, but not limited to, a remote control, a monitor, a cell phone, a tablet computer, a laptop computer, a medical device (e.g., a pacemaker, a heart rate monitor, etc.), or other consumer electronic device may be situated in the office 900B may include the RF circuit and antenna for receiving RF waves transmitted by the PC workstation 300.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

It should be appreciated that the logical operations described herein with respect to the various figures may be implemented (1) as a sequence of computer implemented acts or program modules (i.e., software) running on a computing device, (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

1. A receiver for receiving radio frequency waves, comprising:
one or more antennas that receive radio frequency waves;
a power conversion circuit that extracts energy from the radio frequency waves; and
a controller that provides the energy to at least one of a load and a battery.

2. The receiver of claim 1, wherein the receiver is integrated into at least one of a wireless mouse, a remote control, a cell phone, a wireless keyboard, a vehicle, or a medical device.

3-7. (canceled)

8. The receiver of claim 1, wherein the radio frequency waves are transmitted by at least one of a laptop, a computer workstation, a television, a gaming console, or a USB device.

9. The receiver of claim 1, wherein the power conversion circuit comprises at least one of an impedance matching circuit, a rectifier circuit, a multiplier circuit, or a power regulation circuit.

10. A wireless recharging system, comprising:
a transmitter that transmits radio frequency waves to an associated receiver;
a receiver that receives the radio frequency waves and extracts energy from the radio frequency waves; and
a controller that stores the extracted energy in one or more batteries.

11. The wireless recharging system of claim 10, wherein:
the transmitter is integrated into a laptop or a computer workstation; and
the receiver is integrated into a wireless mouse or a wireless keyboard.

12. The wireless recharging system of claim 10, wherein:
the transmitter is integrated into a television or a gaming console; and
the receiver is integrated into a remote control.

13. The wireless recharging system of claim 10, wherein the receiver is integrated into at least one of a cell phone, a wireless mouse, a wireless keyboard, a remote control, or a medical device.

14. (canceled)

15. The wireless recharging system of claim 10, wherein the transmitter is associated with a USB device.

16. The wireless recharging system of claim 10, wherein the transmitter is integrated into at least one of a laptop, a computer workstation, a television, or a gaming console.

17. The wireless recharging system of claim 10, wherein at least one of the transmitter or the receiver comprises at least one of an impedance matching circuit, a rectifier circuit, a multiplier circuit, or a power regulation circuit.

18. A method for wirelessly harvesting power, comprising:
transmitting radio frequency waves to a receiver;
receiving, using one or more antennas, the radio frequency waves; and
extracting energy from the radio frequency waves.

19. The method of claim 18, further including using the extracted energy to power a consumer electronic device.

20. The method of claim 18, further including storing the extracted energy within one or more batteries.

21. The method of claim 18, wherein the receiver is associated with at least one of a wireless mouse, a wireless keyboard, a remote control, or a medical device.

22. (canceled)

23. (canceled)

24. The method of claim 18, wherein the transmitter is associated with a television, a gaming console, a computer workstation, or a laptop.

25. The method of claim 18, wherein the transmitter is associated with a television or a gaming console, and the receiver is associated with a remote control.

26. The method of claim 18, wherein the transmitter is associated with a USB device.

27. The method of claim 18, further including:
determining when the batteries have been fully charged; and
notifying a user that the batteries have been fully charged.

28. The method of claim 27, further including:
sending, from the receiver to the transmitter, a request for the transmitter to enter standby mode after the batteries have been fully charged.
